(19) United States
(12) Patent Application Publication
(10) Pub. No.: US 2007/0119457 A1
(43) Pub. Date: May 31, 2007

(54) Breath purifying device

(76) Inventor: William Barrick, Conroe, TX (US)

Correspondence Address: Browning Bushman PC, Suite 1800, 5718 Westheimer, Houston, TX, 77057-5771, US

(21) Appl. No.: 11/290,033

(22) Filed: Nov. 30, 2005

(51) Int. Cl. A62B 7/10

(52) U.S. Cl. 128/205.29; 128/202.27; 128/205.27

(57) ABSTRACT

A breathing device 10 for purifying a user's breath includes a snorkel 12 and a canister 18 in fluid communication with the snorkel. A plurality of fiber layers 28 each treated with a breath deodorizer one or more canister discs 26 separating two of the fiber layers, and a discharge hole 42 in the canister generally opposite the canister input end.

### FIELD OF THE INVENTION

The present invention relates to devices for purifying the exhaled air from a user to reduce breath odor. More particularly, the invention is directed to a breath purifying device for use by a hunter or naturalist to reduce the likelihood of game smelling the odor from the user's breath.

### BACKGROUND OF THE INVENTION

Various techniques have been used to reduce the likelihood of game smelling the odor from a hunter or naturalist. Some techniques involve the owner abstaining from certain types of spicy or exotic foods several days before planning a hunt, taking chlorophyll tablets before a hunt to reduce body odor, and rubbing areas of the body with an alcohol or vinegar. Nevertheless, breath of the hunter or naturalist contains odor, and often that breath odor is sufficient to alert animals to man's presence. Devices have been designed specifically to reduce odor. Such devices generally are not able to sufficiently reduce odors that are not detected by animals downstream from the hunter. Other devices are awkward to use, or otherwise interfere with the hunter's actions.

U.S. Pat. 5,117,821 discloses a hunting mask with an exhalation tube between the mask and a canister containing charcoal granules. The device uses a one-way air intake valve and a one-way discharge valve for discharging breath from the canister to atmosphere. Publication U.S. 2002/0221841 is directed to a breathing device for reducing fogging of lenses caused by breath vapor, and includes an air purifying bag or canister with charcoal granules. Other patents of interest are U.S. Pat. Nos. 5,036,842, 5,697,205, and 6,070,578.

The disadvantages of the prior art are overcome by the present invention, and an improved breath purifying device is hereinafter disclosed which may be used by hunters, naturalists, and others to reduce their odor.

### SUMMARY OF THE INVENTION

In one embodiment, a breathing device for purifying a user's breath prior to discharge includes a snorkel having a mouth end and a canister input end, and a breath purifying canister in fluid communication with the snorkel and housing a plurality of fiber layers within the canister, each fiber layer being treated with a breath deodorizer. At least one disc within the canister includes one or more flow passageways and separates two of the plurality of fiber layers. An activated charcoal layer is provided in the canister, and at least one breath discharge hole in the canister is opposite the canister input end.

In another embodiment, the breathing device includes a snorkel and canister, with a plurality of fiber layers within the canister each treated with a breath deodorizer, and at least one of the fiber layers is treated with sodium bicarbonate. At least one disc within the canister separates two of the plurality of fiber layers, and a breath discharge hole in the canister is provided opposite the canister input end.

In yet another embodiment, a breath purifying device includes a snorkel and a canister, and a plurality of polyester fiber layers within the canister, each fiber layer being treated with at least one of sodium bicarbonate, hydrogen peroxide and aluminum sulphate. At least one disc within the canister has one or more flow passageways and separates two of the plurality of fiber layers. At least one breath discharge hole in the canister is provided opposite the canister input end.

These and further features and advantages of the present invention will become apparent from the following detailed description, wherein reference is made to the figures in the accompanying drawings.

### BRIEF DESCRIPTION OF THE DRAWINGS

FIG. 1 is an exploded view of one embodiment of the breathing device according to the present invention.

FIG. 2 illustrates another embodiment of a breathing device with a plastic material canister.

FIG. 3 illustrates yet another embodiment of a breathing device with a flexible hose snorkel and an axially shortened canister.

FIG. 4 illustrates a further embodiment of a breathing device canister with an input cap permanently attached to a sleeve-shaped canister body and a removable cover at the output end of the canister body.

FIG. 5 is a cross-sectional view of one embodiment of a breathing device with layers placed within the canister.

FIG. 6 is a bottom view of the canister shown in FIG. 5, illustrating a screen material for retaining the activated charcoal in place.

FIG. 7 illustrates another embodiment of an axially shortened canister with baffle layers.

FIG. 8 is a side view of a portion of the canister shown in FIG. 7.

FIG. 9 is a top view of the canister lid shown in FIG. 8.

### DESCRIPTION OF THE PREFERRED EMBODIMENTS

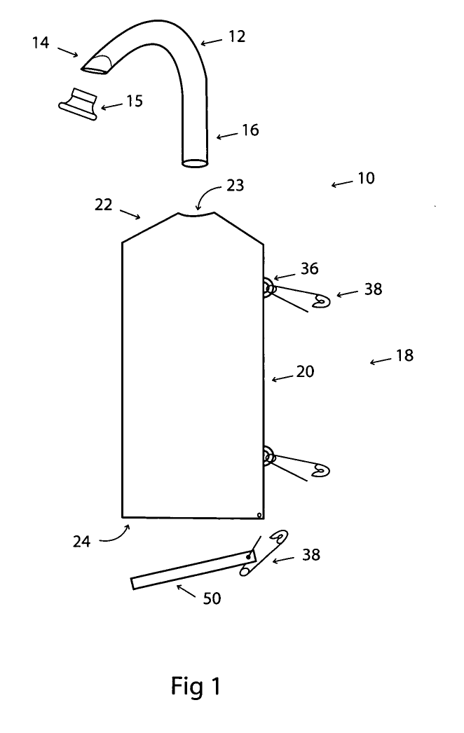

FIG. 1 depicts one embodiment of a breathing device 10 suitable for use by a hunter to purify a hunter's breath prior to discharge. The breathing device 10 comprises a plastic material snorkel 12 having a mouth end 14 for fitting within the mouth of the hunter, and a canister input end 16 opposite the mouth end for sealing with the canister 18. The canister or container preferably may be cylindrical shaped, although other configuration containers may be used. Also, a mouthpiece 15 may be included on the mouth end 14 of the snorkel 12, with the mouth end of the snorkel partially flattened or otherwise configured to be tightly secured to the mouthpiece.

The breath purification canister 18 includes a generally sleeve-shaped body 20, an input cap 22 having a hole 23 therein for receiving the snorkel 12, and an output cap 18 having one or more holes for discharging purified breath to the environment. Each end cap 22, 24 may be threaded, glued, or otherwise secured to the housing 20 in a manner which eliminates or substantially reduces any leakage between the components. A hunter preferably breaths in through his nose and discharges air through his mouth and through the snorkel 12 and the canister 18.

Referring to FIG. 6, one or more discs 26 each having at least one hole therein may be positioned in the canister housing 20 so that each disc is generally perpendicular to an axis of the housing, with each disc separating one treated fiber layer 28 from another treated fiber layer. The embodiment as shown in FIG. 6 contains four fabric layers 28 and one activated charcoal layer 30. The uppermost layer 28 is separated from the middle layer by a disc 26 which, in one embodiment, includes a plurality of holes 40 spaced generally about or near the periphery of the disc. The second fiber layer 28 is separated from the third fiber layer by another disc, which may include a single generally centered hole 41 in this disc. The third fiber layer may be separated from the fourth fiber layer by another disc which includes a plurality of holes 40 about its periphery, as previously described. This varying pattern of holes in the disc thus ensures good air flow through each of the fiber layers, increasing the reaction between the breath and the purifying fibers.

The canister also preferably includes an activated charcoal layer 30, with the charcoal layer 30 preferably being positioned adjacent a netting or screen material 32. The netting or screen layer 32 as shown in FIG. 6 is preferably provided between the activated charcoal layer 30 and the holes 42 in the discharge cover 24 to prevent activated charcoal from falling out of the canister. If desired, a similar netting or screen layer may be provided to separate the activated charcoal layer from the fiber layer immediately above the activated charcoal layer. In other embodiments, the disc 26 themselves may be screen layers, such that the plurality of flow passageways in the screen layer allows the passage of air, and separates one fiber layer from another fiber layer or from an activated charcoal layer.

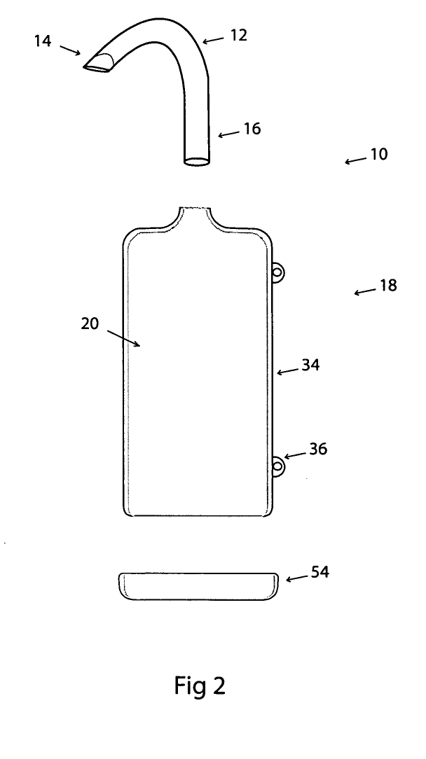

When the breathing device is assembled and ready for use by the hunter, the canister may be placed within a camouflage bag 34, as shown in FIG. 2, which may include a tie string at the top thereof for positioning over the canister and about the snorkel. The bag 34 may include one or more tags 36 secured to the material of the bag 34. A conventional bronze safety pin or other securing member 38 may then be used to removably secure the breathing device to the jacket, cap, or other clothing of the hunter. One safety pin may be used to receive an upper end of the bag 34 about the snorkel 12, thereby replacing the need for a tie string.

In one embodiment, each of the fiber layers is treated with sodium bicarbonate which acts as a breath deodorizer. The sodium bicarbonate may be mixed with water, then the mixture soaked in or applied to polyester fibers, then the fibers allowed to dry. This provides a large surface area for high reaction between the odors in the breath and the sodium bicarbonate. Providing multiple layers with a disc between two layers further ensures interaction between the treated fiber layers and the breath, since the discharged breath passes through one fiber layer and then through the holes in a disc before passing downstream through another layer.

In other embodiments, one or more of the layers is treated with one of hydrogen peroxide or aluminum sulphate. Also, polyester fibers are a suitable material for carrying the breath deodorizer in the canister, however, other material fiber layers could be used in other applications. Hydrogen peroxide acts as an anti-bacterial agent, and also absorbs odors. Fibers may thus be treated with hydrogen peroxide, preferably in a formulation less than 10%, and the fibers with the hydrogen peroxide then dried and placed within a canister. Another alternative is to treat the fibers with aluminum sulphate. Aluminum sulphate is more effective in reducing odors in moist breath than in a dry medium.

FIG. 1 shows a further feature of the invention, wherein an absorbent wick formed from felt or a cloth material may be secured to the bag 34 by a safety pin 38. The wick 50 may be dipped in a suitable cover scent, such as pine, sagebrush or an animal scent to mask the human scent and/or further confuse the hunted animal.

In one embodiment, the sleeve-shaped housing 20 itself is formed from a wrapped paper or other fibrous material, thereby providing a low manufacturing cost and minimizing noise when in use. In other embodiments, the canister may be fabricated from a plastic material.

FIG. 2 illustrates an alternative embodiment, wherein the mouth end 14 of a snorkel 12 is not adapted for a mouthpiece. The tabs 36 on the bag 34 are shown, although the safety pins or other attachment devices are not depicted. In the FIG. 2 embodiment, a base cover 54 may be fitted over the lower end of the sleeve-shaped canister body 20 after the various layers are installed within the canister. The base cover 54 may then be permanently affixed to the canister, or if desired may be removably affixed to the canister, thereby allowing reuse of a canister with fresh deodorizing material. Also, the canister body 20 as shown in FIG. 2, and optionally the base cover 54, may each be formed from a plastic material.

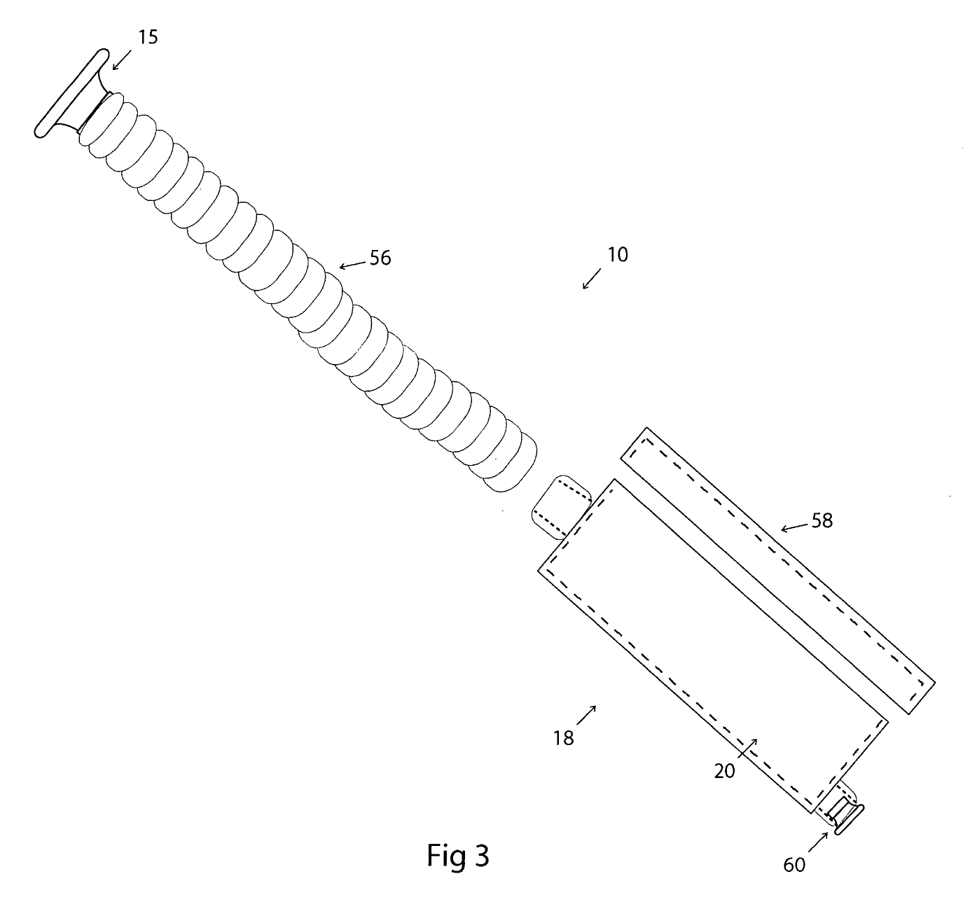

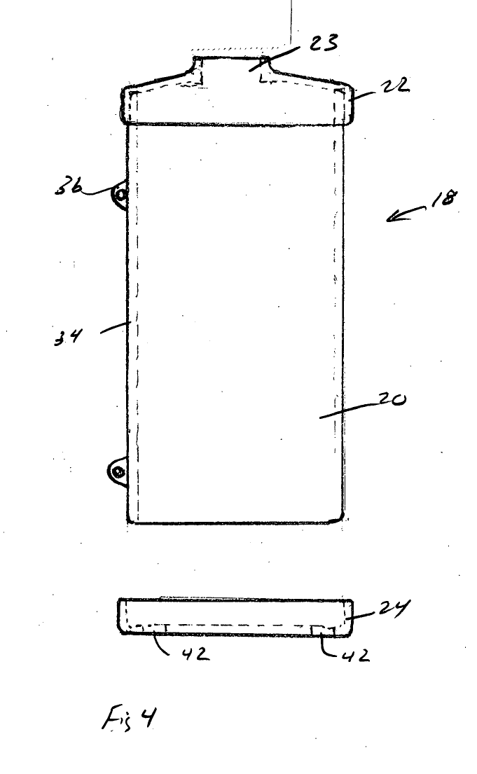

FIG. 3 depicts yet another embodiment, wherein a substantially rigid snorkel is replaced with a flexible hose snorkel 56, with a mouthpiece 15 provided on the end of the flexible snorkel. In this embodiment, the cylindrical shaped housing 20 is axially relatively short, but the canister has a larger diameter, thereby having more of a “pancake” shape. Discharged air may pass through the snorkel 56 and to a periphery of the canister, and may be discharged from the canister through a plurality of holes provided in a circumferentially opposing periphery of the canister, or through holes in the cover 58 which are circumferentially generally opposite the inlet. After the various fiber layers and the activated charcoal layer are placed within the canister, a lid 58 may be placed over the body of the canister to retain the purifying materials in place. FIG. 3 also illustrates a drain plug 60 which is provided in the side of canister body 20 circumferentially opposite the intake to the canister, thereby allowing moisture from the user's breath which accumulates within the canister to be drained from the canister.

FIG. 4 illustrates yet another embodiment, wherein the snorkel may be similar to any of the embodiments shown in FIGS. 1-3. The canister 18 includes an inlet cap 22 and an outlet cap 24 each attached to the sleeve-shaped body 20 of the canister 18. Cap 22 may thus slide over the upper end of the sleeve 20, and may be permanently attached to the upper end of the sleeve. A central hole 23 for receiving the snorkel is provided in the inlet cap 22. The outlet cap 24 preferably has a plurality of holes 42 as previously discussed, and may either be permanently or removably secured to the sleeve-shaped canister. FIG. 4 also illustrates the camouflage cloth bag 34 and the securing tabs 36.

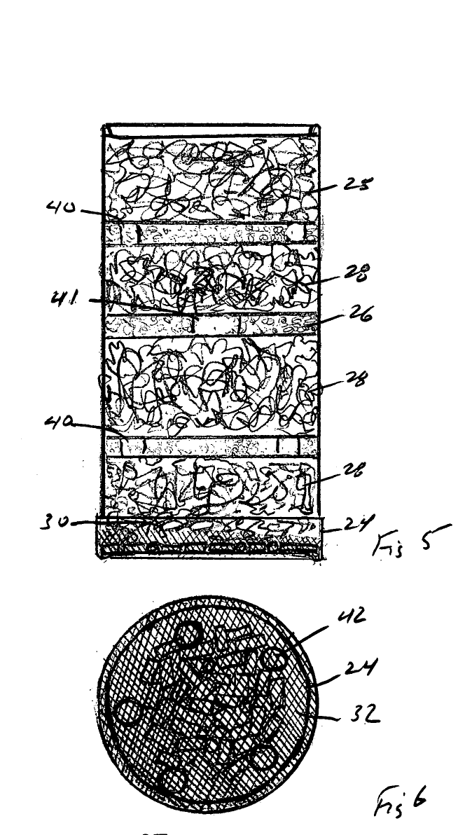

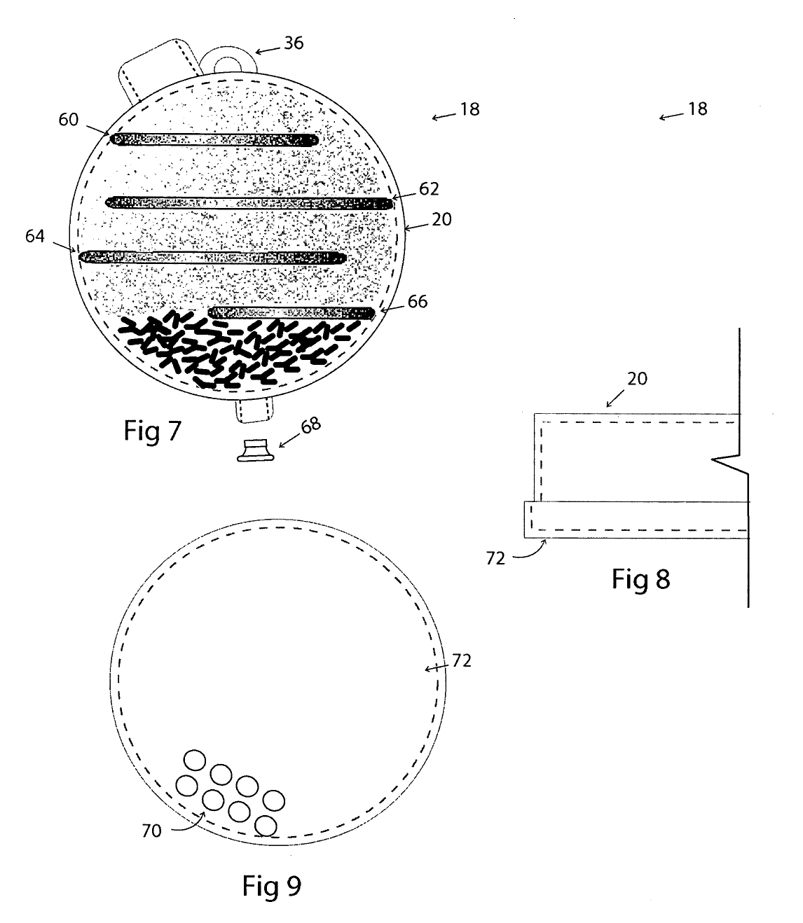

FIG. 7 discloses another embodiment of a breathing device, where the snorkel may be any of the embodiments described above. In this embodiment, the canister is a large diameter member which is axially short compared to the prior embodiments, thereby having more of a “pancake” configuration. Attachment point 36 is thus provided adjacent the portion of the canister which will be the top portion when worn by a hunter. The snorkel may thus input breath into the upper portion of the body 20. This embodiment includes a plurality of baffles 60, each of which is secured at one end to a side wall of the housing 20, with the cantilevered opposing end of each baffle being positioned within the interior of the housing. Air thus travels to the right of top baffle 60, to the left of the second baffle 62, to the right of the third baffle 64, and to the left of the fourth baffle 66 shown in FIG. 7. As with the FIG. 3 embodiment, air enters a periphery of the canister. Air exit holes 70 may be provided in the lower portion of the cover or lid 72, and a drain plug 68 provided at a location generally radially opposite the attachment point 36. The baffles may each of the closed cell foam construction, and serve a cough noise suppression purpose in addition to a separation of the fibrous layers and control of flow through the canister. FIG. 8 shows the cover 72 on the body 20 of the canister.

The term “snorkel” as used herein is intended to refer to any type of flow tube suitable for fitting between the user's mouth and a canister.

The term “disc” as used herein to refer to any generally sheet-shaped divider which may be placed within the canister to separate one fiber layer from another fiber layer, while allowing flow passages through holes in the disc or divider and/or between the disc or divider and the canister wall. The disc or divider need not have a generally circular configuration. Discs, which include noise suppression baffles, may also have varying configurations within a canister, as shown in FIG. 7.

Other embodiments may include a check valve in the snorkel to allow air to pass inward to the snorkel and into the lungs of the hunter, while preventing exhaled air from passing outward without first passing through the canister.

The invention as discussed above has particular utility for a hunter. In other situations, a breathing device may be useful for naturalist attempting to film wild game.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A breathing device for purifying a user's breath prior to discharge, comprising:
a snorkel having a mouth end for fitting the mouth of the user;
a breath purification canister in fluid communication with a canister input end of the snorkel opposite the mouth end;
a plurality of fiber layers within the canister, each fiber layer treated with a breath deodorizer;
at least one disk within the canister having one or more flow passageways and separating two of the plurality of fiber layers;
an activated charcoal layer in the canister; and
at least one breath discharge hole in the canister generally opposite the canister input end.

2. A breathing device as defined in claim 1, wherein at least one of the fiber layers comprises polyester fibers.

3. A breathing device as defined in claim 1, wherein at least one of the fiber layers is treated with sodium bicarbonate.

4. A breathing device as defined in claim 3, wherein sodium bicarbonate is mixed with water, the mixture subjected to the fibers, and the fibers with mixture dried before placing the fibers within the canister.

5. A breathing device as defined in claim 1, wherein at least one of the fiber layers is treated with hydrogen peroxide.

6. A breathing device as defined in claim 1, wherein at least one of the fiber layers is treated with aluminum sulphate.

7. A breathing device as defined in claim 1, further comprising:
a screen between the activated charcoal layer and the at least one breath. discharge hole.

8. A breathing device as defined in claim 1, wherein the canister is formed from a fibrous material.

9. A breathing device as defined in claim 1, further comprising:
a camouflage layer over an exterior surface of the canister; and
a fastener secured to the camouflage layer for removably attaching the canister to clothing on the user.

10. A breathing device as defined in claim 1, wherein each of the plurality of fiber layers is spaced between the canister input end of the snorkel and the activated charcoal layer.

11. A breathing device for purifying a user's breath prior to discharge, comprising:
a snorkel having a mouth end for fitting the mouth of the user;
a breath purification canister in fluid communication with a canister input end of the snorkel opposite the mouth end, the canister formed from a fibrous material;
a plurality of fiber layers within the canister, each fiber layer treated with a breath deodorizer, at least one of the fiber layers treated with sodium bicarbonate;
at least sheet divider within the canister having one or more flow passageways and separating two of the plurality of fiber layers; and
at least one breath discharge hole in the canister generally opposite the canister input end.

12. A breathing device as defined in claim 11, wherein the fiber layer comprises polyester fibers.

13. A breathing device as defined in claim 11, wherein at least one of the fiber layers is treated with one of hydrogen peroxide and aluminum sulphate.

14. A breathing device as defined in claim 11, further comprising:
an activated charcoal layer within the canister.

15. A breathing device as defined in claim 14, further comprising:
a screen adjoining the activated charcoal layer to prevent activated charcoal from passing out the at least one breath discharge hole.

16. A breathing device for purifying a hunter's breath prior to discharge, comprising:
a snorkel having a mouth end for fitting the mouth of the hunter;
a breath purification canister in fluid communication with a canister input end of the snorkel opposite the mouth end;
a plurality of polyester fiber layers within the canister, each fiber layer treated with at least one of sodium bicarbonate, hydrogen peroxide, and aluminum sulphate;
at least one sheet divider within the canister having one or more flow passageways and separating two of the plurality of fiber layers; and
at least one breath discharge hole in the canister generally opposite the canister input end.

17. A breathing device as defined in claim 16, wherein the canister is formed from a fibrous material.

18. A breathing device as defined in claim 17, when canister includes a camouflage layer over an exterior surface of the canister.

19. A breathing device as defined in claim 16, wherein a treatment material is mixed with water, the mixture subjected to the fibers, and the fibers with mixture dried before placing the fibers within the canister.

20. A breathing device as defined in claim 16, further comprising:
an activated charcoal layer within the canister.
